(19) United States
(12) Patent Application Publication
(10) Pub. No.: US 2015/0322327 A1
(43) Pub. Date: Nov. 12, 2015

(54) Sugar Cane Ash in Spacer Fluids

(71) Applicant: Halliburton Energy Services, Inc., Houston, TX (US)

(72) Inventors: Jiten Chatterji, Duncan, OK (US); Thomas Jason Pisklak, Cypress, TX (US); Darrell Chad Brenneis, Marlow, OK (US); James Robert Benkley, Duncan, OK (US)

(73) Assignee: HALLIBURTON ENERGY SERVICES, INC., Houston, TX (US)

(21) Appl. No.: 14/363,377

(22) PCT Filed: May 9, 2014
(86) PCT No.: PCT/US2014/037538

§ 371 Date: Jun. 6, 2014

(51) Int. Cl. C09K 8/40; E21B 33/14

(52) U.S. Cl. CPC C09K 8/40; E21B 33/14

(57) ABSTRACT

Disclosed are spacer fluids and methods of use in subterranean formations. Embodiments may include using a spacer fluid comprising sugar cane ash and water to displace a drilling fluid in a wellbore.

### BACKGROUND

Embodiments relate to spacer fluids for use in subterranean operations and, more particularly, in certain embodiments, to spacer fluids that comprise sugar cane ash and methods of use in subterranean formations.

In cementing operations, such as well construction and remedial cementing, cement compositions are commonly utilized. Cement compositions may be used in primary cementing operations whereby pipe strings, such as casing and liners, are cemented in wellbores. In a typical primary cementing operation, a cement composition may be pumped into an annulus between the exterior surface of the pipe string disposed therein and the walls of the wellbore (or a larger conduit in the wellbore). The cement composition may set in the annular space, thereby forming an annular sheath of hardened, substantially impermeable material (i.e., a cement sheath) that may support and position the pipe string in the wellbore and may bond the exterior surface of the pipe string to the wellbore walls (or the larger conduit). Among other things, the cement sheath surrounding the pipe string should function to prevent the migration of fluids in the annulus, as well as protect the pipe string from corrosion. Cement compositions may also be used in remedial cementing methods, such as in squeeze cementing for sealing voids in a pipe string, cement sheath, gravel pack, subterranean formation, and the like. Cement compositions may also be used in surface applications, for example, construction cementing.

Preparation of the wellbore for cementing operations may be important in achieving optimal zonal isolation. Conventionally, wellbores may be cleaned and prepared for the cement composition with a fluid train that precedes the cement composition and can include spacer fluids, flushes, water-based muds, and the like. Spacer fluids may be used in wellbore preparation for drilling fluid displacement before introduction of the cement composition. The spacer fluids may enhance solids removal while also separating the drilling fluid from a physically incompatible fluid, such as a cement composition. Spacer fluids may also be placed between different drilling fluids during drilling change outs or between a drilling fluid and completion brine. Certain components of spacer fluids may be limited and/or restricted in some geographical locations.

### BRIEF DESCRIPTION OF THE DRAWINGS

These drawings illustrate certain aspects of some of the embodiments of the present invention, and should not be used to limit or define the invention.

FIG. 1 is a schematic illustration of an example system for the preparation and delivery of a spacer fluid comprising sugar cane ash to a wellbore.

FIG. 2 is a schematic illustration of example surface equipment that may be used in the placement of a spacer fluid comprising sugar cane ash into a wellbore.

FIG. 3 is a schematic illustration of an example in which a spacer fluid comprising sugar cane ash is used between a cement composition and a drilling fluid.

FIG. 4 is a schematic illustration of the embodiment of FIG. 3 showing displacement of the drilling fluid.

### DETAILED DESCRIPTION

Embodiments relate to spacer fluids for use in subterranean operations and, more particularly, in certain embodiments, to spacer fluids that comprise sugar cane ash and methods of use in subterranean formations. In accordance with present embodiments, the spacer fluids may improve the efficiency of wellbore cleaning and wellbore fluid removal. One of the many potential advantages to these methods and compositions is that an effective use for sugar cane ash may be provided thus minimizing the amount of the waste being deposited in disposal sites, such as containment reservoirs. Another potential advantage of these methods and compositions is that the cost of subterranean operations may be reduced by replacement of higher cost additives (e.g., surfactants, weighting agents, etc.) with the sugar cane ash. Yet another potential advantage of these methods and compositions is that the sugar cane ash may be used in place of other additives such as cement kiln dust whose supply may be limited in certain geographic locations.

The spacer fluids may generally comprise sugar cane ash and water. Embodiments of the spacer fluids comprising the sugar cane ash may be consolidating. For example, the spacer fluids may consolidate to develop gel strength or compressive strength when placed in the wellbore. Accordingly, the spacer fluid left in the wellbore may function to provide a substantially impermeable barrier to seal off formation fluids and gases and consequently serve to mitigate potential fluid migration. The spacer fluid in the wellbore annulus may also protect the pipe string or other conduit from corrosion. The spacer fluid may also serve to protect the erosion of the cement sheath formed by subsequently introduced cement compositions.

The spacer fluids generally should have a density suitable for a particular application as desired by those of ordinary skill in the art, with the benefit of this disclosure. In some embodiments, the spacer fluids may have a density in the range of from about 4 pounds per gallon (“ppg”) to about 24 ppg. In other embodiments, the spacer fluids may have a density in the range of about 4 ppg to about 17 ppg. In yet other embodiments, the spacer fluids may have a density in the range of about 8 ppg to about 13 ppg. Embodiments of the spacer fluids may be foamed or unfoamed or comprise other means to reduce their densities known in the art, such as lightweight additives. Those of ordinary skill in the art, with the benefit of this disclosure, should recognize the appropriate density for a particular application.

As used herein, the term “sugar cane ash” refers to a solid waste/by-product produced when bagasse is burned in boilers in the sugarcane and alcohol industries. Bagasse is the fibrous remains after sugarcane or sorghum stalks are crushed to extract their sugar. Sugar cane ash may also be known as “sugarcane bagasse ash.” The bagasse may be burned to provide energy for sugar mills or alcohol plants (e.g., a cellulosic ethanol plant). In the process of burning the bagasse, sugarcane ash is produced which is a waste product that typically must be disposed of in a disposal site. In Brazil, for example, approximately 2.5 million tons of sugar cane ash are produced each year. Typically, the sugar cane ash may be used as a soil fertilizer. As previously described, the sugar cane ash is often disposed of as a waste, but may include any ash that is specifically produced from the sources described herein for use in the various embodiments of this disclosure. The sugar cane ash may be provided in any suitable form, including as dry solids or as a fluid (including viscous fluids such as a sludge or slurry), which may comprise sugar cane ash and water.

Burn duration and burn temperature, for example, may impact the composition of the sugar cane ash obtained from the bagasse. The burn temperature, as used herein, refers to the temperature at which the bagasse is exposed during the burning and not to the temperature of the bagasse itself. It should be understood that the bagasse may be burned at a wide variety of times and temperatures to produce sugar cane ash suitable for use in embodiments of the present invention. By way of example, the bagasse may be burned for about 2 hours to about 8 hours and, alternatively, for about 3 hours to about 6 hours. In certain embodiments, the bagasse may be burned for about 5 hours. By way of further example, the bagasse may be burned at a temperature of about 400° C. to about 900° C. and, alternatively, of about 500° C. to about 700° C. In certain embodiments, the bagasse may be burned at a temperature of about 600° C. It should be understand that burn times and burn temperatures outside those listed in this disclosure may also be suitable for the present embodiments.

While the chemical analysis of sugar cane ash will typically vary from various manufacturers depending on a number of factors, including the particular material feed, process conditions, treatments, and the like, sugar cane ash typically may comprise a mixture of solid and metallic oxide-bearing minerals. By way of example, the sugar cane ash may comprise a number of different oxides (based on oxide analysis), including, without limitation, Na₂O, MgO, Al₂O₃, SiO₂, CaO, SO₃, K₂O, TiO₂, Mn₂O₃, ZnO, SrO, and/or Fe₂O₃. Moreover, the sugar cane ash generally may comprise a number of different crystal structures, including, without limitation, quartz (SiO₂), K-feldspar, Na-feldspar, and/or muscovite.

The sugar cane ash may, in some embodiments, serve as a low cost component in spacer fluids. In addition, the sugar cane ash may have pozzolanic activity such that the spacer fluids comprising the sugar cane ash may consolidate to develop compressive strength. In some embodiments, lime may be included in the spacer fluid for activation of the sugar cane ash for consolidation of the spacer fluid. In further embodiments, a cement set activator (e.g., calcium chloride) may be included in the spacer fluid in combination with or in addition to the lime for activation of the sugar cane ash. Additional pozzolanic materials such as pumice may also be included in the spacer fluids.

Further, the sugar cane ash may be included in the spacer fluids in a crushed, ground, powder, or other suitable particulate form. In some embodiments, the sugar cane ash may have a d50 particle size distribution of from about 1 micron to about 200 microns and, alternatively, from about 10 microns to about 50 microns. By way of example, the sugar cane ash may have a d50 particle size distribution ranging between any of and/or including any of about 1 micron, about 5 microns, about 10 microns, about 20 microns, about 30 microns, about 40 microns, about 50 microns, about 60 microns, about 70 microns, about 80 microns, about 90 microns, about 100 microns, about 150 microns, or about 200 microns. One of ordinary skill in the art, with the benefit of this disclosure, should be able to select an appropriate particle size for the sugar cane ash for a particular application.

The sugar cane ash may be included in the spacer fluids in an amount suitable for a particular application. For example, the sugar cane ash may be included in the spacer fluids in an amount in the range of from about 0.1% to about 80% by weight of the spacer fluid. By way of further example, the sugar cane ash may be present in an amount ranging between any of and/or including any of about 0.1%, about 1%, about 10%, about 20%, about 30%, about 40%, about 50%, about 60%, about 70%, or about 80% by weight of the spacer fluid. In some embodiments, the sugar cane ash may be present in an amount of about 50% to about 70% by weight of the spacer fluid. One of ordinary skill in the art, with the benefit of this disclosure, should recognize the appropriate amount of the sugar cane ash to include for a chosen application.

The water used in the spacer fluids may include, for example, freshwater, saltwater (e.g., water containing one or more salts dissolved therein), brine (e.g., saturated saltwater produced from subterranean formations), seawater, or any combination thereof. Generally, the water may be from any source, provided that the water does not contain an excess of compounds that may undesirably affect other components in the spacer fluid. The water may be included in an amount sufficient to form a pumpable slurry. For example, the water may be included in the spacer fluids in an amount in the range of from about 40% to about 200% by weight of the sugar cane ash and, alternatively, in an amount in a range of from about 40% to about 150% by weight of the sugar cane ash. By way of further example, the water may be present in an amount ranging between any of and/or including any of about 40%, about 50%, about 60%, about 70%, about 80%, about 90%, about 100%, about 110%, about 120%, about 130%, about 140%, about 150%, about 160%, about 170%, about 180%, about 190%, or about 200% by weight of the sugar cane ash. One of ordinary skill in the art, with the benefit of this disclosure, should recognize the appropriate amount of the water to include for a chosen application.

The spacer fluids may optionally comprise lime. As previously mentioned, the lime may be included in a spacer fluid for activation of the sugar cane ash. Further, in some embodiments, the lime may comprise hydrated lime. As used herein, the term “hydrated lime” will be understood to mean calcium hydroxide. In some embodiments, the lime may be provided as quicklime (calcium oxide) which hydrates when mixed with water to form a hydrated lime. Where present, the lime may be included in the spacer fluids in an amount in the range of from about 1% to about 100% by weight of the sugar cane ash, for example. In some embodiments, the lime may be present in an amount ranging between any of and/or including any of about 1%, about 5%, about 10%, 20%, about 40%, about 60%, about 80%, or about 100% by weight of the sugar cane ash. One of ordinary skill in the art, with the benefit of this disclosure, should recognize the appropriate amount of lime to include for a chosen application.

The spacer fluids may optionally comprise kiln dust. “Kiln dust,” as that term is used herein, refers to a solid material generated as a by-product of the heating of certain materials in kilns. The term “kiln dust” as used herein is intended to include kiln dust made as described herein and also equivalent forms of kiln dust. Kiln dust such as certain cement kiln dusts may exhibits cementitious properties in that it can set and harden in the presence of water. Examples of suitable kiln dusts include cement kiln dust, lime kiln dust, and combinations thereof. Cement kiln dust may be generated as a by-product of cement production that is removed from a gas stream and collected, for example, in a dust collector. Usually, large quantities of cement kiln dust are collected in the production of cement that are commonly disposed of as waste. Disposal of the cement kiln dust can add undesirable costs to the manufacture of the cement, as well as create environmental concerns associated with the disposal. The chemical analysis of the cement kiln dust from various cement manufactures varies depending on a number of factors, including the particular kiln feed, the efficiencies of the cement production operation, and the associated dust collection systems. Cement kin dust generally may comprise a variety of oxides, such as SiO₂, Al₂O₃, Fe₂O₃, CaO, MgO, SO₃, Na₂O, and K₂O. Problems may also be associated with the disposal of lime kiln dust, which may be generated as a by-product of the calcination of lime. The chemical analysis of lime kiln dust from various lime manufacturers varies depending on a number of factors, including the particular limestone or dolomitic limestone feed, the type of kiln, the mode of operation of the kiln, the efficiencies of the lime production operation, and the associated dust collection systems. Lime kiln dust generally may comprise varying amounts of free lime and free magnesium, lime stone and/or dolomitic limestone, other components such as chlorides, and a variety of oxides such as SiO₂, Al₂O₃, Fe₂O₃, CaO, MgO, SO₃, Na₂O, and/or K₂O.

The kiln dust may be included in the spacer fluids in an amount suitable for a particular application. Where present, the kiln dust may be included in an amount in a range of from about 1% to about 200% by weight of the sugar cane ash. By way of example, the kiln dust may be present in an amount ranging between any of and/or including any of about 1%, about 20%, about 40%, about 60%, about 80%, about 100%, about 120%, about 140%, about 160%, about 180%, or about 200% by weight of the sugar cane ash. In one particular embodiment, the kiln dust may be present in an amount in a range of from about 25% to about 75% by weight of sugar cane ash and, alternatively, from about 40% to 60% by weight of the sugar cane ash. One of ordinary skill in the art, with the benefit of this disclosure, should recognize the appropriate amount of kiln dust to include for a chosen application.

The spacer fluids may optionally comprise pumice. Generally, pumice is a volcanic rock that may exhibit pozzolanic properties. Embodiments of the pumice may have a d50 particle size in a range of from about from about 1 micron to about 200 microns. An example of a suitable pumice is available from Hess Pumice Products, Inc., Malad, Id., as DS-325 lightweight aggregate, having a particle size of less than about 15 microns. Where used, the pumice generally may be included in the spacer fluids in an amount desired for a particular application. In some embodiments, pumice may be included in the spacer fluids in an amount in the range of from about 1% to about 100% by weight of the sugar cane ash. In some embodiments, the pumice may be present in an amount ranging between any of and/or including any of about 1%, about 5%, about 10%, 20%, about 40%, about 60%, about 80%, or about 100% by weight of the sugar cane ash. One of ordinary skill in the art, with the benefit of this disclosure, should recognize the appropriate amount of the pumice to include for a chosen application.

The spacer fluids may optionally comprise barite. In some embodiments, the barite may be sized barite. Sized barite generally refers to barite that has been separated, sieved, ground, or otherwise sized to produce barite having a desired particle size. For example, the barite may be sized to produce barite having a particle size of about 200 microns or less. Where used, the barite generally may be included in the spacer fluids in an amount desired for a particular application. In some embodiments, the barite may be present in an amount in a range of from about 1% to about 100% by weight of the sugar cane ash. For example, the barite may be present in an amount ranging between any of and/or including any of about 1%, about 5%, about 10%, 20%, about 40%, about 60%, about 80%, or about 100% by weight of the sugar cane ash. One of ordinary skill in the art, with the benefit of this disclosure, should recognize the appropriate amount of the barite to include for a chosen application.

The spacer fluids may optionally include a cement set activator to activate the pozzolanic reaction of the sugar cane ash. Examples of suitable cement set activators include, but are not limited to: amines such as triethanolamine, diethanolamine; silicates such as sodium silicate; zinc formate; calcium acetate; Groups IA and IIA hydroxides such as sodium hydroxide, magnesium hydroxide, and calcium hydroxide; monovalent salts such as sodium chloride; divalent salts such as calcium chloride; and combinations thereof. The cement set activator may be added to embodiments of the spacer fluids in an amount sufficient to induce the spacer fluid set into a hardened mass. In certain embodiments, the cement set activator may be added to the spacer fluid in an amount in the range of about 0.1% to about 20% by weight of the sugar cane ash. In specific embodiments, the cement set activator may be present in an amount ranging between any of and/or including any of about 0.1%, about 1%, about 5%, about 10%, about 15%, or about 20% by weight of the sugar cane ash. One of ordinary skill in the art, with the benefit of this disclosure, should recognize the appropriate amount of the cement set activator to include for a chosen application.

A wide variety of additional additives may be included in the spacer fluids as deemed appropriate by one skilled in the art, with the benefit of this disclosure. Examples of such additives include, but are not limited to: supplementary cementitious materials, weighting agents, viscosifying agents (e.g., clays, hydratable polymers, guar gum), fluid loss control additives, lost circulation materials, filtration control additives, dispersants, foaming additives, defoamers, corrosion inhibitors, scale inhibitors, formation conditioning agents, and a water-wetting surfactants. Water-wetting surfactants may be used to aid in removal of oil from surfaces in the wellbore (e.g., the casing) to enhance cement and consolidating spacer fluid bonding. Examples of suitable weighting agents include, for example, materials having a specific gravity of 3 or greater, such as barite. Specific examples of these, and other, additives include: organic polymers, biopolymers, latex, ground rubber, surfactants, crystalline silica, amorphous silica, silica flour, fumed silica, nano-clays (e.g., clays having at least one dimension less than 100 nm), salts, fibers, hydratable clays, microspheres, rice husk ash, micro-fine cement (e.g., cement having an average particle size of from about 5 microns to about 10 microns), metakaolin, zeolite, shale, Portland cement, Portland cement interground with pumice, perlite, barite, slag, lime (e.g., hydrated lime), gypsum, and any combinations thereof, and the like. A person having ordinary skill in the art, with the benefit of this disclosure, should readily be able to determine the type and amount of additive useful for a particular application and desired result.

As previously mentioned, the spacer fluids may consolidate after placement in the wellbore. By way of example, the spacer fluids may develop gel and/or compressive strength when left in the wellbore. As a specific example of consolidation, when left in a wellbore annulus (e.g., between a subterranean formation and the pipe string disposed in the subterranean formation or between the pipe string and a larger conduit disposed in the subterranean formation), the spacer fluid may consolidate to develop static gel strength and/or compressive strength. The consolidated mass formed in the wellbore annulus may act to support and position the pipe string in the wellbore and bond the exterior surface of the pipe string to the walls of the wellbore or to the larger conduit. The consolidated mass formed in the wellbore annulus may also provide a substantially impermeable barrier to seal off formation fluids and gases and consequently also serve to mitigate potential fluid migration. The consolidated mass formed in the wellbore annulus may also protect the pipe string or other conduit from corrosion.

In some embodiments, the spacer fluids may consolidate to develop compressive strength. By way of example, spacer fluids comprising sugar cane ash, water, and optional additives may develop a 24-hour compressive strength of about 50 psi, about 100 psi, or greater. In some embodiments, the compressive strength values may be determined at a temperature ranging from 100° F. to 200° F. Compressive strength is generally the capacity of a material or structure to withstand axially directed pushing forces. Typical sample geometry and sizes for measurement are similar to, but not limited to, those used for characterizing oil well cements: 2 inch cubes; or 2 inch diameter cylinders that are 4 inches in length; or 1 inch diameter cylinders that are 2 inches in length; and other methods known to those skilled in the art of measuring “mechanical properties” of oil well cements. For example, the compressive strength may be determined by crushing the samples in a compression-testing machine. The compressive strength is calculated from the failure load divided by the cross-sectional area resisting the load and is reported in units of pound-force per square inch (psi). Compressive strengths may be determined in accordance with API RP 10B-2, Recommended Practice for Testing Well Cements, First Edition, July 2005.

Embodiments of the spacer fluids may be prepared in accordance with any suitable technique. In some embodiments, the desired quantity of water may be introduced into a mixer (e.g., a cement blender) followed by the dry blend. The dry blend may comprise the sugar cane ash and additional solid additives (e.g., pumice, kiln dust, barite, and the like), for example. Additional liquid additives, if any, may be added to the water as desired prior to, or after, combination with the dry blend. This mixture may be agitated for a sufficient period of time to form a pumpable slurry. By way of example, pumps may be used for delivery of this pumpable slurry into the wellbore. As will be appreciated by those of ordinary skill in the art, with the benefit of this disclosure, other suitable techniques for preparing the spacer fluids may be used in accordance with embodiments of the present invention.

An example method may include a method of displacing a first fluid from a wellbore, the wellbore penetrating a subterranean formation. The method may comprise providing a spacer fluid that comprises sugar cane ash and water. One or more optional additives may also be included in the spacer fluid as discussed herein. The method may further comprise introducing the spacer fluid into the wellbore to displace at least a portion of the first fluid from the wellbore. In some embodiments, the spacer fluid may displace the first fluid from a wellbore annulus, such as the annulus between a pipe string and the subterranean formation or between the pipe string and a larger conduit. In some embodiments, the first fluid displaced by the spacer fluid comprises a drilling fluid. By way of example, the spacer fluid may be used to displace the drilling fluid from the wellbore. In addition to displacement of the drilling fluid from the wellbore, the spacer fluid may also remove the drilling fluid from the walls of the wellbore. Additional steps in embodiments of the method may comprise introducing a pipe string into the wellbore, introducing a cement composition into the wellbore with the spacer fluid separating the cement composition and the first fluid. In an embodiment, the cement composition may be allowed to set in the wellbore. The cement composition may include, for example, cement and water.

Another example method may comprise using a spacer fluid comprising sugar cane ash and water to displace a drilling fluid in a wellbore. One or more optional additives may also be included in the spacer fluid as discussed herein. The method may further comprise introducing a cement composition into the wellbore after the spacer fluid, wherein the spacer fluid separates the cement composition from the drilling fluid. Any of the embodiments of a spacer fluid described herein may apply in the context of this example method.

Another example method may comprise using a spacer fluid comprising sugar cane ash, hydrated lime, and water to displace an aqueous drilling fluid in a wellbore annulus. The method may further comprise introducing a cement composition into the wellbore annulus after the spacer fluid. At least a portion of the spacer fluid may consolidate in the wellbore annulus to form a hardened mass. One or more optional additives may also be included in the spacer fluid as discussed herein. Any of the embodiments of a spacer fluid described herein may apply in the context of this example method.

An embodiment may provide a system comprising: a cement composition for use in cementing in a wellbore; a spacer fluid for separating the cement composition from a drilling fluid in the wellbore, wherein the spacer fluid comprising sugar cane ash and water; mixing equipment for mixing the spacer fluid; and pumping equipment for delivering the spacer fluid into a wellbore. One or more optional additives may also be included in the spacer fluid as discussed herein. Any of the embodiments of a spacer fluid described herein may apply in the context of this example system.

An example spacer fluid composition may comprise sugar cane ash and water. One or more optional additives (e.g., a cement set activator) may also be included in the spacer fluid as discussed herein. Any of the embodiments of a spacer fluid described herein may apply in the context of this example composition.

As described herein, the spacer fluid may prevent the cement composition from contacting the first fluid, such as a drilling fluid. The spacer fluid may also remove the drilling fluid, dehydrated/gelled drilling fluid, and/or filter cake solids from the wellbore in advance of the cement composition. Embodiments of the spacer fluid may improve the efficiency of the removal of these and other compositions from the wellbore. Removal of these compositions from the wellbore may enhance bonding of the cement composition to surfaces in the wellbore.

The displaced drilling fluid may include, for example, any number of fluids, such as solid suspensions, mixtures, and emulsions. In some embodiments, the drilling fluid may comprise an oil-based drilling fluid. An example of a suitable oil-based drilling fluid comprises an invert emulsion. In some embodiments, the oil-based drilling fluid may comprise an oleaginous fluid. Examples of suitable oleaginous fluids that may be included in the oil-based drilling fluids include, but are not limited to, α-olefins, internal olefins, alkanes, aromatic solvents, cycloalkanes, liquefied petroleum gas, kerosene, diesel oils, crude oils, gas oils, fuel oils, paraffin oils, mineral oils, low-toxicity mineral oils, olefins, esters, amides, synthetic oils (e.g., polyolefins), polydiorganosiloxanes, siloxanes, organosiloxanes, ethers, acetals, dialkylcarbonates, hydrocarbons, and combinations thereof.

The cement composition introduced into the well bore may comprise hydraulic cement and water. In some embodiments, kiln dust may be used in place of some (e.g., up to about 50% by weight or more) or all of the hydraulic cement. A variety of hydraulic cements may be utilized in accordance with the present invention, including, but not limited to, those comprising calcium, aluminum, silicon, oxygen, iron, and/or sulfur, which set and harden by reaction with water. Suitable hydraulic cements include, but are not limited to, Portland cements, pozzolana cements, gypsum cements, high alumina content cements, slag cements, silica cements, and combinations thereof. In certain embodiments, the hydraulic cement may comprise a Portland cement. In some embodiments, the Portland cements may include cements classified as Classes A, C, H, or G cements according to American Petroleum Institute, API Specification for Materials and Testing for Well Cements, API Specification 10, Fifth Ed., Jul. 1, 1990. In addition, in some embodiments, the hydraulic cement may include cements classified as ASTM Type I, II, or III.

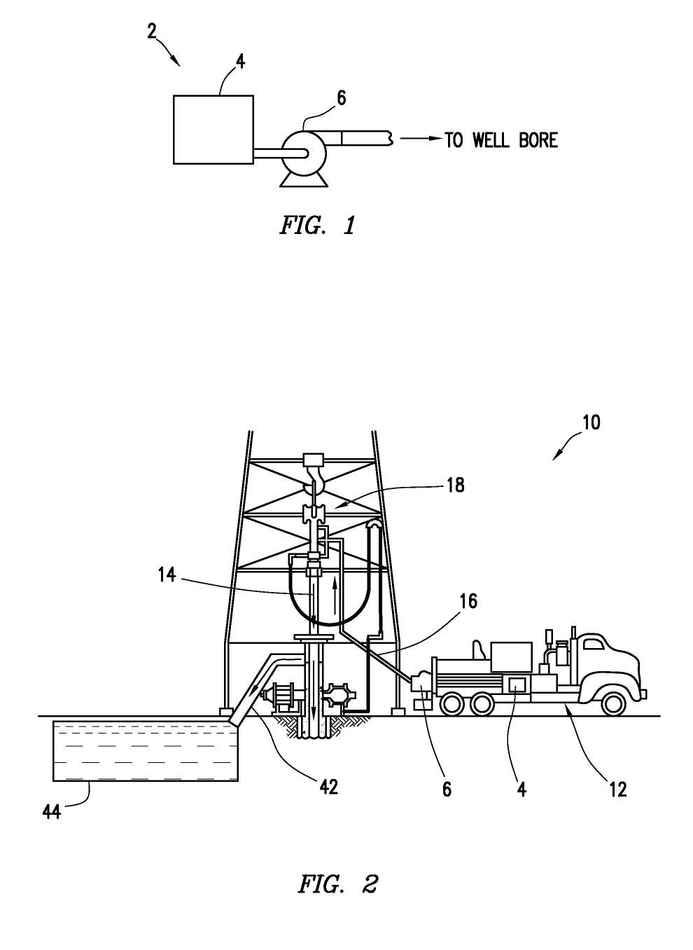

Example methods of using the spacer fluids comprising sugar cane ash in well cementing will now be described in more detail with reference to FIGS. 1-4. FIG. 1 illustrates an example system 2 for preparation of a spacer fluid comprising sugar cane ash and water and delivery of the spacer fluid to a wellbore. As shown, the spacer fluid may be mixed in mixing equipment 4, such as a jet mixer, re-circulating mixer, or a batch mixer, for example, and then pumped via pumping equipment 6 to the wellbore. In some embodiments, the mixing equipment 4 and the pumping equipment 6 may be disposed on one or more cement trucks as will be apparent to those of ordinary skill in the art. In some embodiments, a jet mixer may be used, for example, to continuously mix a dry blend comprising the sugar cane ash and one or more optional additives described herein, for example, with the water as it is being pumped to the wellbore. Any of the embodiments of a spacer fluid described herein may apply in the context of FIG. 1.

FIG. 2 illustrates example surface equipment 10 that may be used in placement of a spacer fluid and/or cement composition. It should be noted that while FIG. 2 generally depicts a land-based operation, those skilled in the art will readily recognize that the principles described herein are equally applicable to subsea operations that employ floating or sea-based platforms and rigs, without departing from the scope of the disclosure. As illustrated by FIG. 2, the surface equipment 10 may include a cementing unit 12, which may include one or more cement trucks. The cementing unit 12 may include mixing equipment 4 and pumping equipment 6 as will be apparent to those of ordinary skill in the art. The cementing unit 12 may pump a spacer fluid and/or cement composition in the direction indicated by arrows 14 through a feed pipe 16 and to a cementing head 18 which conveys the fluid downhole. Any of the embodiments of a spacer fluid described herein may apply in the context of FIG. 2 with respect to the spacer fluid. For example, the spacer fluid may comprise sugar cane ash, water, and one or more optional additives.

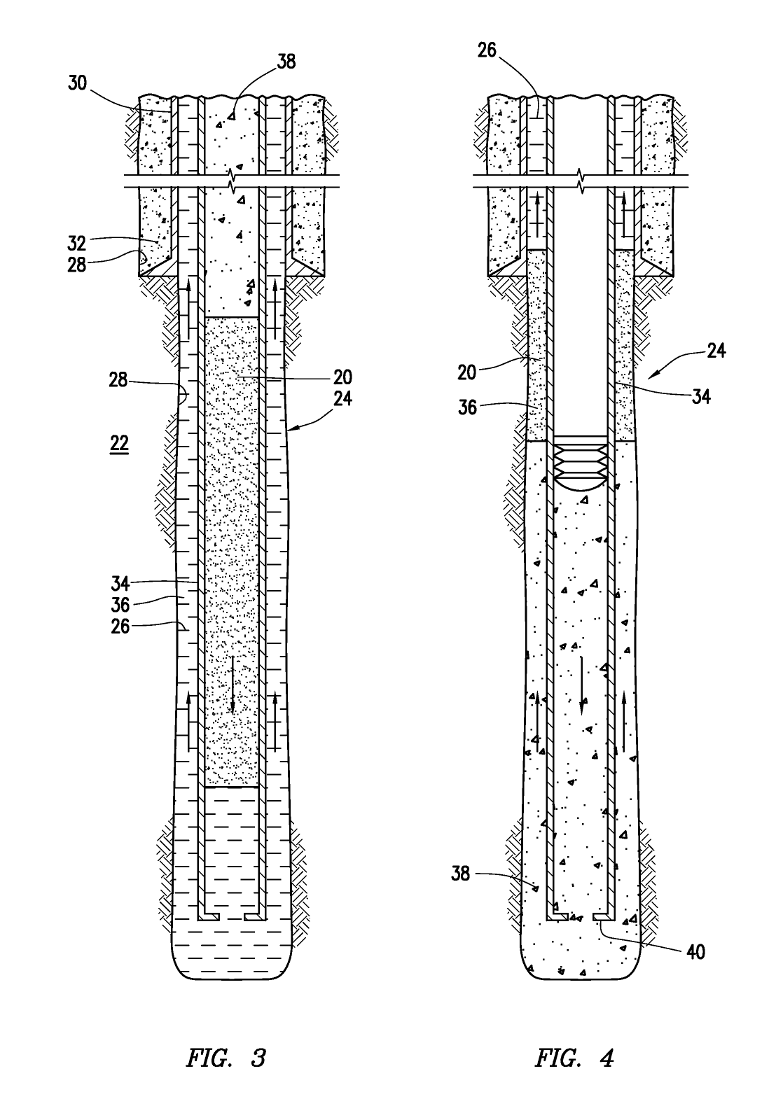

An example of using a spacer fluid 20 comprising sugar cane ash will now be described with reference to FIG. 3. Any of the embodiments of a spacer fluid described herein may apply in the context of FIG. 3 with respect to the spacer fluid 20. For example, the spacer fluid 20 may comprise sugar cane ash, water, and one or more optional additives.

FIG. 3 depicts one or more subterranean formations 22 penetrated by a wellbore 24 with drilling fluid 26 disposed therein. The drilling fluid 26 may include the example drilling fluids disclosed herein as well as other suitable drilling fluids that will be readily apparent to those of ordinary skill in the art. While the wellbore 24 is shown extending generally vertically into the one or more subterranean formations 22, the principles described herein are also applicable to wellbores that extend at an angle through the one or more subterranean formations 22, such as horizontal and slanted wellbores. As illustrated, the wellbore 24 comprises walls 28. In the illustrated embodiment, a surface casing 30 has been cemented to the walls 28 of the wellbore 24 by cement sheath 32. In the illustrated embodiment, one or more additional pipe strings (e.g., intermediate casing, production casing, liners, etc.), shown here as casing 34 may also be disposed in the wellbore 24. As illustrated, there is a wellbore annulus 36 formed between the casing 34 and the walls 28 of the wellbore 24 (and/or the surface casing 30). While not shown, one or more centralizers may be attached to the casing 30, for example, to centralize the casing 34 in the wellbore 24 prior to and during the cementing operation.

As illustrated, a cement composition 38 may be introduced into the wellbore 24. For example, the cement composition 38 may be pumped down the interior of the casing 34. The pump 6 shown on FIGS. 1 and 2 may be used for delivery of the cement composition 38 into the wellbore 24. It may be desired to circulate the cement composition 38 in the wellbore 24 until it is in the wellbore annulus 36. The cement composition 38 may include the example cement compositions disclosed herein as well as other suitable cement compositions that will be readily apparent to those of ordinary skill in the art. While not illustrated, other techniques may also be utilized for introduction of the cement composition 38. By way of example, reverse circulation techniques may be used that include introducing the cement composition 38 into the wellbore 24 by way of the wellbore annulus 36 instead of through the casing 34.

The spacer fluid 20 may be used to separate the drilling fluid 26 from the cement composition 38. The previous embodiments described with reference to FIG. 1 for preparation of a spacer fluid may be used for delivery of the spacer fluid 20 into the wellbore 24. Moreover, the pump 6 shown on FIGS. 1 and 2 may also be used for delivery of the spacer fluid 20 into the wellbore 24. The spacer fluid 20 may be used with the cement composition 38 for displacement of the drilling fluid 26 from the wellbore 24 as well as preparing the wellbore 24 for the cement composition 38. By way of example, the spacer fluid 20 may function, inter alia, to remove the drilling fluid 26, drilling fluid 26 that is dehydrated/gelled, and/or filter cake solids from the wellbore 24 in advance of the cement composition 38. While not shown, one or more plugs or other suitable devices may be used to physically separate the drilling fluid 26 from the spacer fluid 20 and/or the spacer fluid 20 from the cement composition 38.

Referring now to FIG. 4, the drilling fluid 26 has been displaced from the wellbore annulus 36 in accordance with certain embodiments. As illustrated, the spacer fluid 20 and the cement composition 38 may be allowed to flow down the interior of the casing 34 through the bottom of the casing 34 (e.g., casing shoe 40) and up around the casing 34 into the wellbore annulus 36, thus displacing the drilling fluid 26. At least a portion of the displaced drilling fluid 26 may exit the wellbore annulus 36 via a flow line 42 and be deposited, for example, in one or more retention pits 44 (e.g., a mud pit), as shown in FIG. 2. Turning back to FIG. 4, the cement composition 38 may continue to be circulated until it has reached a desired location in the wellbore annulus 36. The spacer fluid 20 and/or the cement composition 38 may be left in the wellbore annulus 36. As illustrated, the spacer fluid 20 may be disposed in the wellbore annulus 36 above or on top of the cement composition 38. The cement composition 38 may set in the wellbore annulus 36 to form an annular sheath of hardened, substantially impermeable material (i.e., a cement sheath) that may support and position the casing 34 in the wellbore 24. As previously mentioned, embodiments of the spacer fluid 20 may consolidate in the wellbore annulus 36. Thus, the spacer fluid 20 may help to stabilize the casing 34 while also serving to provide a barrier to protect the portion of the casing 34 from corrosive effects of water and/or water-based drilling fluids that would otherwise remain in the wellbore annulus 36 above the cement composition 38.

The exemplary sugar cane ash disclosed herein may directly or indirectly affect one or more components or pieces of equipment associated with the preparation, delivery, recapture, recycling, reuse, and/or disposal of the sugar cane ash and associated spacer fluids. For example, the sugar cane ash may directly or indirectly affect one or more mixers, related mixing equipment 4, mud pits, storage facilities or units, composition separators, heat exchangers, sensors, gauges, pumps, compressors, and the like used generate, store, monitor, regulate, and/or recondition the exemplary sugar cane ash and fluids containing the same. The disclosed sugar cane ash may also directly or indirectly affect any transport or delivery equipment used to convey the sugar cane ash to a well site or downhole such as, for example, any transport vessels, conduits, pipelines, trucks, tubulars, and/or pipes used to compositionally move the sugar cane ash from one location to another, any pumps, compressors, or motors (e.g., topside or downhole) used to drive the sugar cane ash, or fluids containing the same, into motion, any valves or related joints used to regulate the pressure or flow rate of the sugar cane ash (or fluids containing the same), and any sensors (i.e., pressure and temperature), gauges, and/or combinations thereof, and the like. The disclosed sugar cane ash may also directly or indirectly affect the various downhole equipment and tools that may come into contact with the sugar cane ash such as, but not limited to, wellbore casing 34, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

### EXAMPLES

To facilitate a better understanding of the present invention, the following examples of some of the preferred embodiments are given. In no way should such examples be read to limit, or to define, the scope of the invention.

### Example 1

A sample of sugar cane ash was obtained from ARC Products, Inc. and subjected to oxide analysis by EDXRF (Energy Dispersive X-Ray Fluorescence) which showed the following composition by weight:

TABLE 1
Full Oxide Analysis of Sugar Cane Ash

| | Full Oxide (wt %) | Loss Corrected (wt %) |
|---|---|---|
| Na₂O | 0.05 | 0.05 |
| MgO | 0.46 | 0.49 |
| Al₂O₃ | 8.03 | 8.49 |
| SiO₂ | 73.05 | 77.21 |
| SO₃ | 0.06 | 0.06 |
| K₂O | 3.09 | 3.26 |
| CaO | 6.84 | 7.23 |
| TiO₂ | 0.44 | 0.47 |
| Mn₂O₃ | 0.08 | 0.08 |
| Fe₂O₃ | 2.49 | 2.63 |
| ZnO | 0.01 | 0.01 |
| SrO | 0.02 | 0.02 |
| LOI | 5.39 | — |
| Moisture | 1.13 | |
| Content | | |

The sample of sugar cane ash was subjected to X-ray diffraction analysis with Rietveld Full Pattern refinement, which showed the following crystalline materials present by weight:

TABLE 2
XRD of Sugar Cane Ash

| Name | Formula | Sugar Cane Ash (wt. %) |
|---|---|---|
| Quartz | SiO₂ | 74.0 |
| K-feldspar | KAlSi₃O₈ | 8.0 |
| Na-feldspar | NaAlSi₃O₈ | 14.0 |
| Muscovite | — | 4.0 |

The sample of the sugar cane ash was also subjected to particle size analysis using a Malvern Mastersizer® 3000 laser diffraction particle size analyzer, which showed the following particle sizes for the sugar cane ash:

TABLE 3
Particle Size Analysis

| Particle Size | |
|---|---|
| Distribution | Sugar cane ash |
| D10 (microns) | 7.89 |
| D50 (microns) | 43.5 |
| D90 (microns) | 280 |

The density of the sample of the sugar cane ash was also determined using a Quantachrome® Ultra Pyc 1200. The density was determined after drying the sample. The sample was dried in a vacuum oven at 180° F. for 24 hours. The density in grams per cubic centimeter is provided in the table below.

TABLE 4
Density Analysis

| Sugar Cane Ash | Density (g/cc) |
|---|---|
| Dried | 3.03 |

### Example 2

Sample spacer fluids were prepared to evaluate the rheological properties of spacer fluids comprising sugar cane ash. To prepare the sample spacer fluids comprising sugar cane ash, the sugar cane ash from Example 1 was used. Two sample spacer fluids, labeled Samples 1 and 2 in the table below, were prepared by mixing the sugar cane ash with fresh water in a Waring blender jar with 4,000 rpm stirring. In Sample 2, lime was blended with the sugar cane ash prior to combination with the water. The blender speed was then increased to 12,000 rpm for about 35 seconds. SA-1015™ Suspending Agent was added to both samples. SA-1015™ Suspending Agent is available from Halliburton Energy Services, Houston, Tex.

Sample No. 1 had a density of 12 ppg and was prepared by mixing 215.4 grams of sugar cane ash and 255.1 grams of water. Sample No. 2 had a density of 12 ppg and was prepared by mixing 193.6 grams of sugar cane ash, 19.4 grams of hydrated lime and 245.8 grams of fresh water. The formulations of both samples are presented in Tables 5 and 6 below. The abbreviation “% bwoa” in the table refers to percent by weight of the sugar cane ash.

TABLE 5
Spacer Fluid Sample 1 Formulation

| | Concentration | Specific | Amount | Slurry Density |
|---|---|---|---|---|
| Material | (% bwoa) | Gravity | (g) | (ppg) |
| Sugar Cane Ash | 100.0 | 3.03 | 215.4 | 12.0 |
| Suspending Agent | 0.5 | 1.47 | 1.08 | |
| Fresh Water | 118.5 | 0.998 | 255.1 | |

TABLE 6
Spacer Fluid Sample 2 Formulation

| | Concentration | Specific | Amount | Slurry Density |
|---|---|---|---|---|
| Material | (% bwoa) | Gravity | (g) | (ppg) |
| Sugar Cane Ash | 100.0 | 3.03 | 193.6 | 12.0 |
| Lime | 10.0 | 2.34 | 19.4 | |
| Suspending Agent | 0.5 | 1.47 | 0.97 | |
| Fresh Water | 126.9 | 0.998 | 245.8 | |

Rheological values were then determined using a Fann Model 35 Viscometer. Dial readings were recorded at speeds of 3, 6, 100, 200, and 300 with a B1 bob, an R1 rotor, and a 1.0 spring. The dial readings for the spacer fluids were measured in accordance with API Recommended Practices 10B, Bingham plastic model and are set forth in the table below. The results provided in the table below are an average of two tests. The abbreviation “% bwoa” in the table refers to percent by weight of the sugar cane ash.

TABLE 7
Rheological Analysis

| | Sugar | Hydrated | | | | | | | | |
|---|---|---|---|---|---|---|---|---|---|---|
| | Cane Ash | Lime | Temp. | Viscometer RPM | | | | | | |
| Sample | (% bwoa) | (% bwoa) | (° F.) | 3 | 6 | 100 | 200 | 300 | 3D | 6D |
| 1 | 100 | 0 | 80 | 4 | 5 | 14 | 20.5 | 28 | 2 | 1 |
| | | | 180 | 3 | 4 | 10 | 15 | 19.5 | 1 | 0.5 |
| 2 | 100 | 10 | 80 | 14 | 14 | 15.5 | 20.5 | 26.5 | 7 | 5 |
| | | | 180* | 5.5 | 5.5 | 8 | 9 | 11.5 | 4 | 4 |

*Settling was observed.

### Example 3

The following test was performed to determine the compressive strength of spacer fluids comprising sugar cane ash. The two samples from Example 2, labeled Samples 1 and 2 in the table below, were poured into 1-inch by 2-inch brass cylinders and cured in a water bath at 180° F. for 72 hours. Immediately after removal from the water bath, destructive compressive strengths were determined using a Tinius Olsen mechanical press in accordance with API RP 10B-2. The results of this test are set forth in Table 8 below. The results are an average of two tests for each sample.

TABLE 8
Compressive Strength Measurements

| Sample | Temp. (° F.) | Time (hrs.) | Compressive Strength (psi) |
|---|---|---|---|
| 1 | 180 | 72 | Did not set |
| 2 | 180 | 72 | Consolidated, but <50 psi |

The preceding description provides various embodiments of the spacer fluids containing different additives and concentrations thereof, as well as methods of using the spacer fluids. It should be understood that, although individual embodiments may be discussed herein, the present disclosure covers all combinations of the disclosed embodiments, including, without limitation, the different additive combinations, additive concentrations, and fluid properties.

It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present invention. If there is any conflict in the usages of a word or term in this specification and one or more patent(s) or other documents that may be incorporated herein by reference, the definitions that are consistent with this specification should be adopted.

What is claimed is:

1. A method comprising:
injecting a non-cementitious spacer fluid comprising sugar cane ash and water;
displacing a drilling fluid in a wellbore with the spacer fluid; wherein the spacer fluid is essentially free of a cement set activator.

2. The method of claim 1 wherein the drilling fluid comprises an oil-based drilling fluid.

3. The method of claim 1 wherein the sugar cane ash is present in an amount of about 0.1% to about 80% by weight of the spacer fluid.

4. The method of claim 1 wherein the sugar cane ash is present in an amount of about 40% to about 70% by weight of the spacer fluid.

5. (canceled)

6. (canceled)

7. (canceled)

8. (canceled)

9. The method of claim 1 wherein the spacer fluid comprises at least one additive selected from the group consisting of a free water control additive, a lightweight additive, a foaming agent, a supplementary cementitious material, a weighting agent of any suitable size, a viscosifying agent, a fluid loss control agent, a lost circulation material, a filtration control additive, a dispersant, a defoamer, a corrosion inhibitor, a scale inhibitor, a formation conditioning agent, a water-wetting surfactant, and any combination thereof.

10. The method of claim 1 wherein the spacer fluid comprises at least one additive selected from the group consisting of gypsum, fly ash, bentonite, hydroxyethyl cellulose, sodium silicate, a hollow microsphere, gilsonite, perlite, a gas, an organic polymer, a biopolymer, latex, ground rubber, a surfactant, crystalline silica, amorphous silica, silica flour, fumed silica, nano-clay, salt, fiber, hydratable clay, rice husk ash, micro-fine cement, metakaolin, zeolite, shale, pumicite, barite, and any combination thereof.

11. The method of claim 1 further comprising pumping the spacer fluid down an interior of a pipe string, out through a bottom of the pipe string, and into a wellbore annulus.

12. The method of claim 1 further comprising introducing a cement composition into the wellbore after the spacer fluid, wherein the spacer fluid separates the cement composition from the drilling fluid.

13. The method of claim 1 further comprising allowing at least a portion of the spacer fluid to remain in the wellbore.

14. The method of claim 13 wherein the portion of the spacer fluid consolidates in the wellbore.

15. A method comprising:
introducing a non-cementitious spacer fluid comprising sugar cane ash, and water into a wellbore annulus, wherein the spacer fluid is essentially free of a cement set activator;
displacing an aqueous drilling fluid in the wellbore annulus;
introducing a cement composition into the wellbore annulus after the spacer fluid; and
wherein at least a portion of the spacer fluid consolidates in the wellbore annulus to form a hardened mass.

16. (canceled)

17. (canceled)

18. A system comprising:
a cement composition for use in cementing in a wellbore;
a non-cementitious spacer fluid for separating the cement composition from a drilling fluid in the wellbore, wherein the spacer fluid comprises sugar cane ash and water, wherein the spacer fluid is essentially free of a cement set activator;
mixing equipment for mixing the spacer fluid; and
pumping equipment for delivering the spacer fluid into a wellbore.

19. (canceled)

20. (canceled)

21. (canceled)

22. (canceled)

23. (canceled)

24. The method of claim 15 wherein the drilling fluid comprises an oil-based drilling fluid.

25. The method of claim 15 wherein the sugar cane ash is present in an amount of about 0.1% to about 80% by weight of the spacer fluid.

26. The method of claim 15 wherein the sugar cane ash is present in an amount of about 40% to about 70% by weight of the spacer fluid.

27. The method of claim 15 wherein the spacer fluid comprises at least one additive selected from the group consisting of a free water control additive, a lightweight additive, a foaming agent, a supplementary cementitious material, a weighting agent of any suitable size, a viscosifying agent, a fluid loss control agent, a lost circulation material, a filtration control additive, a dispersant, a defoamer, a corrosion inhibitor, a scale inhibitor, a formation conditioning agent, a water-wetting surfactant, and any combination thereof.

28. The system of claim 18 wherein the drilling fluid comprises an oil-based drilling fluid.

29. The system of claim 18 wherein the sugar cane ash is present in an amount of about 0.1% to about 80% by weight of the spacer fluid.

30. The system of claim 18 wherein the sugar cane ash is present in an amount of about 40% to about 70% by weight of the spacer fluid.

31. The system of claim 18 wherein the spacer fluid comprises at least one additive selected from the group consisting of a free water control additive, a lightweight additive, a foaming agent, a supplementary cementitious material, a weighting agent of any suitable size, a viscosifying agent, a fluid loss control agent, a lost circulation material, a filtration control additive, a dispersant, a defoamer, a corrosion inhibitor, a scale inhibitor, a formation conditioning agent, a water-wetting surfactant, and any combination thereof.
